(19) United States
(12) Patent Application Publication
(10) Pub. No.: US 2014/0263388 A1
(43) Pub. Date: Sep. 18, 2014

(54) DELIVERY DETECTING SYSTEM AND DELIVERY DETECTING METHOD

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: PENG ZHANG, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/062,630

(22) Filed: Oct. 24, 2013

(30) Foreign Application Priority Data
Mar. 14, 2013 (CN) 2013100809789

(51) Int. Cl. G07F 9/02

(52) U.S. Cl. CPC G07F 9/026
USPC 221/1; 221/2

(57) ABSTRACT

A delivery detecting system includes a Schmidt trigger circuit for receiving a periodic signal, a differential circuit connected to the Schmidt trigger circuit, and a monostable circuit connected to the differential circuit. The Schmidt trigger circuit is used to convert the periodic signal to a first square signal. The differential circuit is used to convert the first square signal to a triangular signal. The monostable circuit is used to convert the triangular signal to a second square signal. The invention further offers a delivery detecting method.

### BACKGROUND

1. Technical Field

The present disclosure relates to delivery detecting systems, and more particularly to a delivery detecting system and a delivery detecting method for an automatic vending machine.

2. Description of Related Art

Vending machines allow customers to buy product twenty four hours a day. The automatic vending machine often comprises a delivery detecting system for detecting product to dispensed by the automatic vending machine. The delivery detecting system comprises a submitting module, a receiving module, and a passageway defined between the submitting module and the receiving module. When the product passes through the passage, an infrared ray emitted by the submitting module is transmitted to the receiving module, and a microcontroller records the exit of the product from the passage in the vending mechanism. When the product enters into the passageway, the delivery detecting system determines whether the product passes through the passageway according to the change of the infrared ray received by the receiving module. However, when the infrared ray is malfunctioning the delivery detecting system cannot obtain a correct judgment. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a block diagram of a delivery detecting system in accordance with an embodiment.

FIG. 2 is a circuit diagram of the delivery detecting system of FIG. 1.

FIG. 3 is a flow chart of a delivery detecting method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

FIGS. 1-2 illustrate a delivery detecting system in accordance with an embodiment. The delivery detecting system comprises a power supply module 10, a detecting module 20 connected to the power supply module 10, a control module 40 connected to the detecting module 20, and a display 30 connected to the detecting module 20. In one embodiment, the delivery detecting system is used in a vending mechanism.

The power supply module 10 comprises a first capacitor C1, a second capacitor C2, and a power supply 11. An input terminal of the power supply 11 is connected to a power source (not shown), and also connected to ground via the first capacitor C1. An output terminal of the power supply 11 is grounded via the second capacitor C2. In one embodiment, the capacitance of the first capacitor C1 is 100 uF, the capacitance of the second capacitor C2 is 4.7 uF, and the model of the power supply 11 is 78L05A.

The detecting module 20 comprises a Schmidt trigger circuit 21, a monostable circuit 22, a differential circuit 23, a data selector 24, and a sliding rheostat 25. The Schmidt trigger circuit 21 comprises a ground pin 1, a low trigger pin 2, an output pin 3, a direct clear pin 4, a high trigger pin 5, and a power supply pin 6. The monostable circuit 22 comprises a ground pin 1, a low trigger pin 2, an output pin 3, a direct clear pin 4, a high trigger pin 5, a power supply pin 6, and a discharge pin 7. The differential circuit 23 comprises a fourth capacitor C4 and a fourth resistor R4.

The ground pin 1 of the Schmidt trigger circuit 21 is grounded. The direct clear pin 4 of the Schmidt trigger circuit 21 and the power supply pin 6 of the Schmidt trigger circuit 21 are connected to the output terminal of the power supply 11. The high trigger pin 5 of the Schmidt trigger circuit 21 and the low trigger pin 2 of the Schmidt trigger circuit 21 are connected to the first node 260. A submitting module (not shown) is connected to the first node 260 via a third capacitor C3 and a first resistor R1. In one embodiment, a resistance of the first resistor R1 is 8.2 KΩ. The submitting module is used to emit a periodic signal, such as a square signal. The first node 260 is connected to the output terminal of the power supply 11, and further connected to a cathode of a first diode D1. An anode of the first diode D1 is connected to a cathode of a second diode D2, and an anode of the second diode D2 is connected to a cathode of a third diode D3. An anode of the third diode D3 is grounded. The first node 260 is connected to the output terminal of power supply 11 via a second resistor R2, and further grounded via a third resistor R3. The output pin 3 of the Schmidt trigger circuit 21 is connected to a second node 261 via the fourth capacitor C4, and the second node 261 is connected to the output terminal of the power supply 11 via the fourth resistor R4. In one embodiment, a resistance of the second resistor R2 is 22 KΩ, a resistance of the third resistor R3 is 22 KΩ, and a resistance of the fourth resistor R4 is 10 KΩ.

The ground pin 1 of the monostable circuit 22 is grounded. The low trigger pin 2 of the monostable circuit 22 is connected to the second node 261. The output terminal 3 of the monostable circuit 22 is connected to an anode of a fourth diode D4. The direct clear pin 4 and the power supply pin 6 of the monostable circuit 22 are connected to the output terminal of the power supply 11. The high trigger pin 5 of the monostable circuit 22 and the discharge pin 7 of the monostable circuit 22 are connected to a third node 262. The third node 262 is grounded via a fifth capacitor C5.

The data selector 24 comprises a first selecting terminal 240, a second selecting terminal 241, a third selecting terminal 242, a fourth selecting terminal 243, and a connecting terminal 244 connected to the third node 262. The connecting terminal 241 can be selectively connected to one of the first selecting terminal 240, the second selecting terminal 241, the third selecting terminal 242, and the fourth selecting terminal 243. When the connecting terminal 241 is connected to the first selecting terminal 240, the delivery detecting system is used to detect a signal which is in a range of 0˜100 HZ. When the connecting terminal 241 is connected to the second selecting terminal 241, the delivery detecting system is used to detect a signal which is in a range of 0˜1000 HZ. When the connecting terminal 241 is connected to the third selecting terminal 240, the delivery detecting system is used to detect a signal which is in a range of 0˜10 KHZ. When the connecting terminal 241 is connected to the fourth selecting terminal 243, the delivery detecting system is used to detect a signal which is in a range of 0˜100 KHZ. The first selecting terminal 240 is connected to the output terminal of the power supply 11 via a fifth resistor R5. The second selecting terminal 241 is connected to the output terminal of the power supply 11 via a sixth resistor R6. The third selecting terminal 242 is connected to the output terminal of the power supply 11 via a seventh resistor R7. The fourth selecting terminal 240 is connected to the output terminal of the power supply 11 via an eighth resistor R8. In one embodiment, a resistance of the fifth resistor R5 is 2.2 MΩ, a resistance of the sixth resistor R6 is 220 MΩ, a resistance of the seventh resistor R7 is 22 KΩ, a resistance of the eight resistor R8 is 2.2 KΩ.

The sliding rheostat 25 comprises two connecting terminals 250 and a sliding terminal 251 located between the two connecting terminals 250. The sliding terminal 251 and a first connecting terminals 250 are grounded via the meter 30, and a second connecting terminal 250 is connected to a cathode of the fourth diode D4

In use, the submitting module emits a first periodic signal, such as a first square signal U. The first square signal U is transmitted to the Schmidt trigger circuit 21 and change to a stable second square signal U1 by passing through the third capacitor C3 and the first resistor R1. The second square signal U1 is changed to a triangular signal U2 by passing through the differential circuit 23. The triangular signal U2 is changed to a third square signal U3 by passing through the monostable circuit 22. The third square signal U3 is the same as the first square signal U. The third square signal U3 is rectified via the fourth diode D4 and displayed via the display 30. Simultaneously, the third square signal U3 is transmitted to the control module 40 to be adjusted to a stable signal. For example, when the third square signal U3 is malfunctioning, the emission frequency of the third square signal U3 is adjusted by the control system, to ensure the delivery detecting system work normally.

FIG. 3 illustrates a delivery detecting method in accordance with an embodiment. The method comprises:

S1: receiving a periodic signal by the Schmidt trigger circuit 21.

S2: converting the periodic signal to a first square signal by the Schmidt trigger circuit 21.

S3: converting the first square signal to a triangular signal by the differential circuit 23.

S4: converting the triangular signal to a second square signal by a monostable circuit 22.

S5: transmitting the second square signal to a control system to be adjusted to a stable signal, so that the detecting module 20 detects whether the product is dispensed by the vending mechanism via the stable signal.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A delivery detecting system comprising:
a detecting module comprising a Schmidt trigger circuit for receiving a periodic signal; a differential circuit connected to the Schmidt trigger circuit; and a monostable circuit connected to the differential circuit; and
a control module connected to the detecting module;
wherein the Schmidt trigger circuit is configured for converting the periodic signal to a first square signal; the differential circuit is configured for converting the first square signal to a triangular signal; the monostable circuit is configured to convert a triangular signal to a second square signal; the second square signal is transmitted to the control system to be adjusted to a stable signal, so that the detecting module detects whether a product is out of a vending mechanism via the stable signal.

2. The delivery detecting system of claim 1, further comprising a first node and a second node; the second node is connected to a power supply module; wherein the Schmidt trigger circuit comprises a low trigger pin connected to the first node and a high trigger pin connected to the first node; the monostable circuit comprises a low trigger pin connected to the second node and a high trigger pin connected to the second node; and the Schmidt trigger circuit is connected to the second node by the differential circuit.

3. The delivery detecting system of claim 2, further comprising a power supply; the power supply is grounded by a first capacitor and a second capacitor; wherein the first node is connected to a third capacitor by a first resistor and connected to the power supply by a second resistor and grounded by a third resistor, the first capacitor is configured to receiving the periodic signal.

4. The delivery detecting system of claim 2, wherein the Schmidt trigger circuit comprises a ground pin grounded, a direct clear pin, and a power supply pin; the power supply pin of the Schmidt trigger circuit and the direct clear pin of the Schmidt trigger circuit are connected to the power supply module, and the monostable circuit comprises a ground pin grounded, a direct clear pin, and a power supply pin; the power supply pin of the monostable circuit and the direct clear pin of the monostable circuit are connected to the power supply module.

5. The delivery detecting system of claim 2, wherein the differential circuit comprises a fourth capacitor and a fourth resistor, and the second node is connected to the power supply by the fourth resistor and connected to the Schmidt trigger circuit by the fourth capacitor.

6. The delivery detecting system of claim 2, further comprising a third node; wherein the monostable circuit comprises a high trigger pin and a discharge pin; the high trigger pin of the monostable circuit and the discharge pin of the monostable circuit are connected to the third node, and the third node is grounded by a fifth capacitor.

7. The delivery detecting system of claim 6, further comprising a data selector connected to the third node, wherein the data selector is connected to the power supply module.

8. The delivery detecting system of claim 7, wherein the data selector comprises a connecting terminal and a plurality of selecting terminals, and the connecting terminal is selectively connected to one of the plurality of selecting terminals.

9. The delivery detecting system of claim 8, wherein each of the plurality of selecting terminals is connected to the power supply by a fifth resistor.

10. The delivery detecting system of claim 1, further comprising a sliding rheostat and a display for displaying the second square signal, wherein the monostable circuit is connected to a diode that is connected to the sliding rheostat; the sliding rheostat comprises two connecting terminals and a sliding terminal located between the two connecting terminals, and the sliding terminal is grounded by the display.

11. A delivery detecting method comprising:
receiving a periodic signal by a Schmidt trigger circuit of a detecting module;
converting the periodic signal to a first square signal by the Schmidt trigger circuit of the detecting module;
converting the first square signal to a triangular signal by a differential circuit of the detecting module;
converting the triangular signal to a second square signal by a monostable circuit of the detecting module; and
transmitting the second square signal to a control system to be adjusted to a stable signal, so that the detecting module detects whether an product is dispensed by the vending mechanism via the stable signal.

12. The delivery detecting method of claim 11, further comprising a first node and a second node; the second node is connected to a power supply module; wherein the Schmidt trigger circuit comprises a low trigger pin connected to the first node and a high trigger pin connected to the first node; the monostable circuit comprises a low trigger pin connected to the second node and a high trigger pin connected to the second node; and the Schmidt trigger circuit is connected to the second node by the differential circuit.

13. The delivery detecting method of claim 12, further comprising a power supply; the power supply is grounded by a first capacitor and a second capacitor; wherein the first node is connected to a third capacitor by a first resistor and connected to the power supply by a second resistor and grounded by a third resistor, the first capacitor is configured to receive the periodic signal.

14. The delivery detecting method of claim 12, wherein the Schmidt trigger circuit comprises a ground pin grounded, a direct clear pin, and a power supply pin; the power supply pin of the Schmidt trigger circuit and the direct clear pin of the Schmidt trigger circuit are connected to the power supply module, and the monostable circuit comprises a ground pin grounded, a direct clear pin, and a power supply pin; the power supply pin of the monostable circuit and the direct clear pin of the monostable circuit are connected to the power supply module.

15. The delivery detecting method of claim 12, wherein the differential circuit comprises a fourth capacitor and a fourth resistor, and the second node is connected to the power supply by the fourth resistor and connected to the Schmidt trigger circuit by the fourth capacitor.

16. The delivery detecting method of claim 12, further comprising a third node; wherein the monostable circuit comprises a high trigger pin and a discharge pin; the high trigger pin of the monostable circuit and the discharge pin of the monostable circuit are connected to the third node, and the third node is grounded by a fifth capacitor.

17. The delivery detecting method of claim 16, further comprising a data selector connected to the third node, wherein the data selector is connected to the power supply module.

18. The delivery detecting method of claim 17, wherein the data selector comprises a connecting terminal and a plurality of selecting terminals, and the connecting terminal is selectly connected to one of the plurality of selecting terminals.

19. The delivery detecting method of claim 18, wherein each of the plurality of selecting terminals is connected to the power supply by a fifth resistor.

20. The delivery detecting method of claim 10, further comprising displaying the second square signal by a display, wherein the monostable circuit is connected to a diode, and the diode is connected to a sliding rheostat; the sliding rheostat comprises two connecting terminals and a sliding terminal located between the two connecting terminals, and the sliding terminal is grounded by the display.
